(19) United States
(12) Patent Application Publication
(10) Pub. No.: US 2004/0108263 A1
(43) Pub. Date: Jun. 10, 2004

(54) Liquid - solids separator

(76) Inventor: Andrew F. Tangeman, Palm Harbor, FL (US)

Correspondence Address: Andrew F. Tangeman, 975 Highlands Blvd., Palm Harbor, FL, 34684, US

(21) Appl. No.: 10/223,114

(22) Filed: Aug. 19, 2002

(51) Int. Cl. B01D 36/04

(52) U.S. Cl. 210/261; 210/407; 210/299; 210/521

(57) ABSTRACT

An improved method of separation of liquids from solids. Animal manure in particular must be separated in order to further process the liquid. This improved method of separation also utilizes a slanted plate clarifier in its design. This design will also provide a means of removing some of the more soluble chemicals from the liquid.

By combining the features required to process the manure the equipment will take up much less space.

The unique screening material will greatly improve the service life of the device as well as reducing maintenance intervals.

### BACKGROUND—FIELD OF INVENTION

This invention relates to liquid/solids separation of animal manure as well as liquid/solids separation from other waste streams. Concentrated Animal Feeding Operators (C.A.F.O.) must conform to new standards of manure management. This invention is a simple method of not only separating the manure solids but also in further processing the liquids.

### BACKGROUND—DESCRIPTION OF PRIOR ART

Many attempts have been made to find a suitable method of removing solids from liquids in order to remedy environmental problems faced by large animal feeding operators.

U.S. Pat. No. 5,268,100 Hartzell teaches us that paddles dragging the manure over a perforated bottom will remove some of the liquids from the solids.

U.S. Pat. No. 3,971,720 Swenson et.al. discloses a method of using a series of drum and roller presses to remove the solids from the liquid.

U.S. Pat. No. 4,830,746 Liabenow et.al. shows us a method of using a device comprised of an elongated conduit that forms a mixing chamber. A chemical is added to the inflow and the filtrate is introduced to a rotating drum that passed the mixture over a perforated screen.

U.S. Pat. No. 4,661,253 Williams discloses a stationary screen inclined at a steep angle. In-flow is introduced at the top of the screen and allows the liquid to drop through the screen as the solids slide to the bottom of the inclined screen.

U.S. Pat. No. 5,171,436 Botsch discloses a bar screen that incorporates a rake device that conducts the screening to the upper end of the bar screen device.

U.S. Pat. No. 4,731,180 Huff discloses perforated filter screen that utilizes a wiper blade or brush to clean the filter screen assembly.

U.S. Pat. No. 4,419,239 Frankl discloses an apparatus for recovering and recycling animal manure and uses and inclined screen and a combination shuttle-driven scraper blades and pressure pads.

These inventions all use a form of solid screen and make few if any provisions for removing excessive liquids from the solids. They make no provision for taking out more of the particulant and unless the manure liquids are further processed the animal feeding operator is unable to land apply the manure.

Manure in order to be used as bedding or to be properly composted should not exceed 65% moisture.

All of the current separators do not provide manure that in most cases is less than 75% moisture.

Therefore, in order to use the manure it is essential that the solids contain no more than 60-65% moisture.

As you will note below, the present invention is distinguishable from other liquid-solids separators by the inclusion in the design of a flexible and moveable delta bar screen and a slanted plate clarifier in a piggy back position. In addition to the flexible properties of the screen, the screen moves after each cycle. The flexible screen is comprised of a series of bars. These bars are molded from a elastomeric urethane/epoxy/micro-fiber matrix. In addition to screening the influent and allowing the liquid to pass between the bars the bars are connected one to the other in a belt like configuration. After each cycle the belt conveys the solids from the liquid-solids separator. The the movement of the delta bar results in a flexing of the bars and removes build up on the screen.

This keeps the screen free of build up of calcium deposits that will blind the screen or freezing which also blinds the screen and decrease the efficient operation of the device.

Two rectangular tanks comprise the main elements of the design. The bottom tank receives the effluent and is fitted with a delta bar screen that also moves and acts as a conveyor.

The influent enters the lower tank at three openings in each side of the tank for a total of six openings.

The influent will flow from the sides of the housing over screens that are slanted at 45 degrees. Some of the liquid will fall through these screens an be evenly distributed over the entire flexible-moveable delta bar screen, much of the liquid portion of the influent will pass between the openings of the flexible-moveable delta bar screen. The solids that remain on the flexible-moveable delta bar screen will require further dewatering. A second tank is mounted directly above the receiving tank. This tankhas four steel posts affixed to the tank, one at each corner. These posts fit into a housing that is affixed to the bottom tank also at each of its four corners. A coil spring resides in each of these housings. The top tank is spring loaded to the open or fill position. Once the flush cycle has been completed the liquid portion in the bottom tank is pumped into the top tank. The weight of the liquid in the top tank overcomes the resistance of the springs and allows the upper tank to lower. A platen is affixed to the bottom of the upper tank and directly in line and the same size as the flexible-moveable delta bar screen As the space is reduced between the platen and the delta bar screen the solids are pressed between the two surfaces. As more liquid is pumped into the upper tank and the space is further reduced the pressure increases and forces more of the liquid from the solids. Once the desired pressure has been reached a solenoid opens a valve and the liquid is drained from the upper tank.

Once the weight is reduced the coil springs will return the upper tank to the open position and allow the influent to again flow onto the moveable delta bar screen.

Once the additional liquid pressed from the solids by the pressure platen, the weight of the upper tank will be reduced allowing the upper tank to return to its open position. This will allow the entire flexible-moveable delta bar screen to move and the solids will be removed from the liquid solids separator and will be sent to the next location for further processing or disposal.

### DESCRIPTION OF THE DRAWINGS

Preferred embodiments are illustrated in the drawings.

FIG. 1. Is a perspective view of the liquid/solids separator and clarifier.

FIG. 2. Is a side view of the liquid/solids separator and clarifier and best illustrates the position of the mounting posts and the clarifier plates.

FIG. 3. Is an end view of the liquid solids separator according to the invention with the top tank w/platen extended.

FIG. 4. Is a a partial section of the flexible-moveable delta bar screen.

FIG. 4. Is a a partial section of the flexible-moveable delta bar screen.

### DETAILED DESCRIPTION OF PREFERRED EMBODIMENT OF THE INVENTION

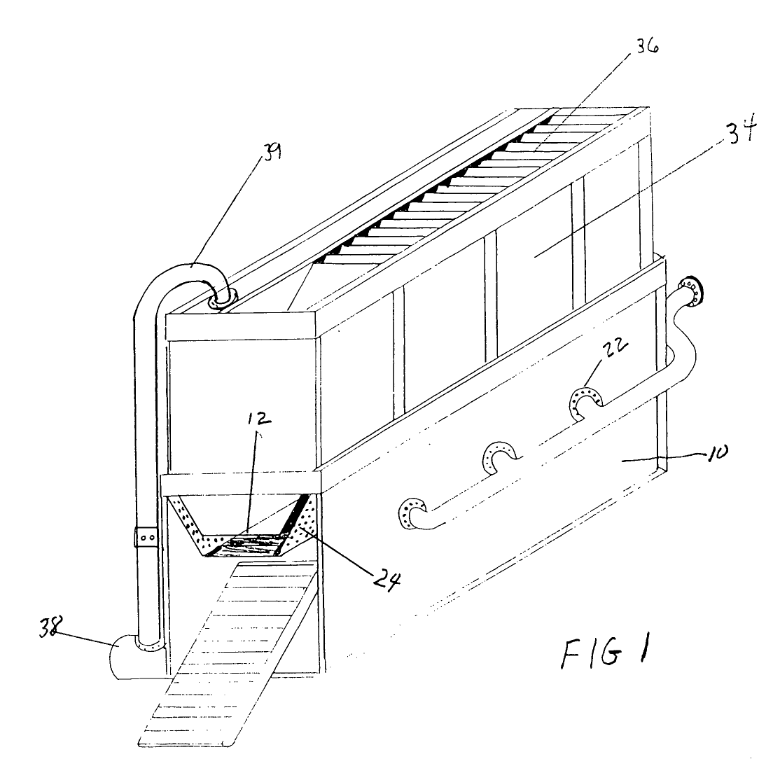

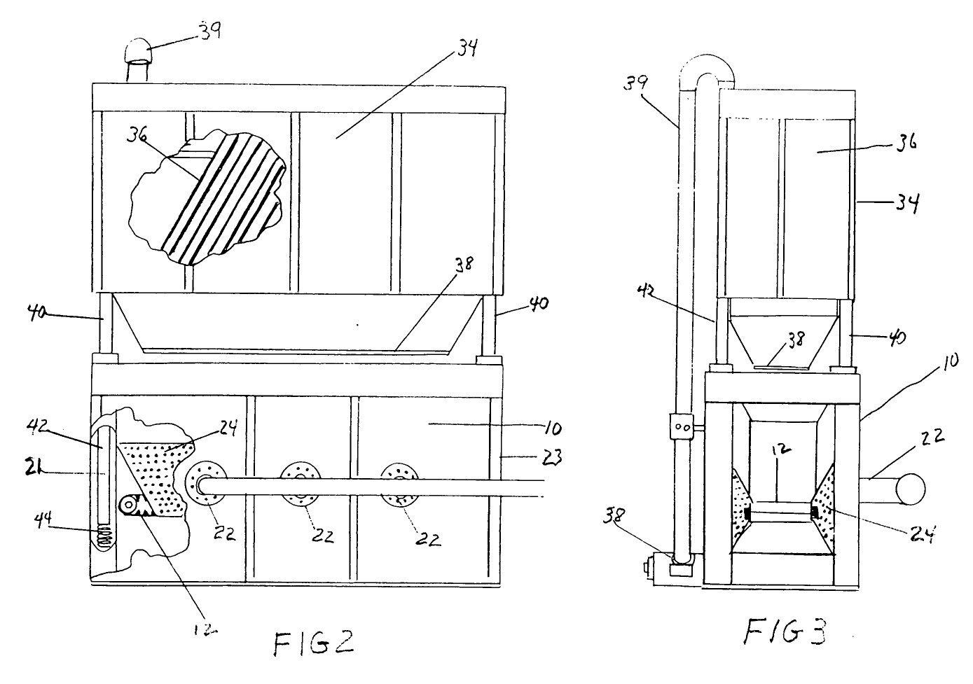

Referring to FIG. 1, the tank 10, wherein the influent is directed. In a constructed embodiment, a moveable delta bar screen 12 extends horizontally between the walls 18 and 20 of the tank 10 to describe an discharge end 21 and a closed end 23. Three apertures 22 are located one third of the distance downward from the top of the walls 18 and 20. These apertures 22 allow the influent to flow over the inclined screens 24 onto the moveable delta bar screen 12. The liquid portion of the influent will pass through the screens 24 and the moveable delta bar screen 12 to the reservoir 32.The moveable delta bar screen 12 can best be seen in FIG. 2. The moveable delta bar screen 12 comprises a plurality of bars cast of elastomeric resin for example a polyurethane resin. The moveable delta bars 12 are cast in are cast as one solid membrane with openings for example of 0.030 to 0.040 in width. Thus the moveable delta bar screen 12 would be comprised of a bar in a delta configuration that would be attached one to the other in a parallel relation but as a solid belt with said openings that allow the liquid to pass between the opening and into the reservoir 32. In accordance with one feature of the instant invention, a tank 34 containing slanted clarifier plates 36 is nested directly above the bottom tank 10. The bottom of the tank 34 conforms to the screens 24 and the bottom of the tank 34 in a horizontal position and parallel to the moveable delta bar screen. The bottom section of this tank 34 is fitted with a platen 38 that covers the entire surface of the bottom of the tank 34. Once the flush cycle is completed and the solid portion of the influent is positioned atop the moveable delta bar screen 12 a electrically driven liquid pump 38 is engaged. This pump is mounted on the outside of tank location 18. The liquid is pumped to the pipe 39 and the liquid is elevated to the top tank 34. The liquid flows into the bottom of the tank 34 and rises up through the slanted clarifier plates 36. At each of the four corners of the upper tank a steel post 40 is permanently affixed to the tank 34. This is best seen in drawing FIG. 2. The steel post 40 is positioned into a housing 42 and that housing contains a coil spring 44. The weight of the liquid in tank 34 increases the entire weight of tank 34 and compresses the coil springs 44. This allows the tank 34 to settle. As the weight in tank 34 increases the platen 36 comes in contact with the solids that rest atop of the moveable delta bar screen 12. This when the platen 36 exerts the pressure againstthe moveable delta bar screen !2 more of the liquid portion of the influent is forced out of the solids and passes through the moveable delta bar screen 12 and into the reservoir. The liquid portion will pass from the bottom of the slanted plates 36 to thetop as this movement will remove more of the particulant from the liquid stream. The drain 48 (not shown) is then opened releasing the liquid from the upper tank 34. As the weight in the tank 34 is reduced the coil springs 44 will return to their extended position and return the upper tank 34 to its extended position and then the next cycle will begin.

I claim:

1. A moveable elastomeric belt in a delta bar configuration that also acts as a conveyor to convey the solids from the liquid solids separator clarifier housing.

2. The use of the weight of the liquid in the upper tank to provide the downward pressure required to force the excess liquid from the remaining solids.

3. The combination of a slanted plate clarifier in combination with a liquid solids separator.
